(19) United States
(12) Patent Application Publication
(10) Pub. No.: US 2021/0205839 A1
(43) Pub. Date: Jul. 8, 2021

(54) THERMOPLASTIC RUBBER DIPPING PROCESS

(71) Applicant: Sabine Crane, San Clemente, CA (US)

(72) Inventor: Sabine Crane, San Clemente, CA (US)

(21) Appl. No.: 17/145,264

(22) Filed: Jan. 8, 2021

Related U.S. Application Data
(60) Provisional application No. 62/958,670, filed on Jan. 8, 2020.

(51) Int. Cl. B05D 1/18; B05D 3/00

(52) U.S. Cl. CPC B05D 1/18; B05D 3/007; B05D 2350/60; B05D 2401/30; B05D 2320/00; B05D 2530/00

(57) ABSTRACT

In a dipping process using thermoplastic rubber (TPR), an object is dipped into melted TPR, removed, and dried in order to provide a TPR coating over the object. The underlying object may be colored with a pattern or illustration and dipped into transparent TPR, or a dyed TPR may be used to provide color to the object. An exemplary use is the manufacturing of pet toys with a TPR coating. However, the process is suitable for use with a variety of materials in a variety of applications, such as providing an insulating coating for wires, a grip for writing utensils, or any other application in which a TPR coating would be useful.

### CROSS-REFERENCE TO RELATED APPLICATIONS

This application claims the benefit of U.S. Provisional Patent Application No. 62/958,670, filed on Jan. 8, 2020, and incorporated herein by reference.

### STATEMENT REGARDING FEDERALLY SPONSORED RESEARCH AND DEVELOPMENT

Not Applicable.

### FIELD OF THE INVENTION

The present invention pertains generally to a process for use in providing a rubber-like coating to an object, and more particularly, to a dipping process for coating an object in thermoplastic rubber (TPR).

### DISCUSSION OF RELATED ART

Thermoplastic elastomers, also referred to as thermoplastic rubber (TPR), is a polymer with rubber-like elasticity at room temperature. A particular advantage of TPRs over thermosetting materials is that TPRs can be melt-processed, and that the process is reversible, allowing TPR products to be easily recycled and remolded into new products.

Due to their suitability for melt processing, TPRs are usually extruded or injection molded into their intended form as product or part. More recently, TPR has been used as a filament in 3D printers, allowing for its use in cottage industries.

Although these manufacturing methods are suitable for many applications, they are be less than adequate in some circumstances in which it would be desirable to coat the surface of an object. Therefore, the need exists for a method of coating an object or a portion of an object with thermoplastic rubber, especially if the object is irregularly shaped, or where it would be desirable to avoid use of an adhesive to bond the TPR to an object. The present invention satisfies these needs.

### SUMMARY OF THE INVENTION

The present invention will provide a method of coating an object or a portion of an object with thermoplastic rubber, especially if the object is irregularly shaped, or where it would be desirable to avoid use of an adhesive to bond the TPR to an object. This is accomplished by forming a melted TPR solution and coating all or a portion of said object in said TPR solution. More specifically, the object is dipped into the melted TPR material, removed, and dried in order to provide a TPR coating over the object. The melted TPR material may be colored with dye, and may provide portions which are uncoated or otherwise have the coating removed. This process is suitable for virtually any object for which a TPR coating is desired.

An exemplary use is for coating pet toys. In a preferred embodiment, the structure of a pet toy is initially formed using canvas formed into the desired shape, such as an animal shape, using canvas of the desired colors and patterns. The canvas pet toy is hung on a suspension apparatus, and a vat of melted transparent TPR is provided. The canvas pet toy is dipped in the TPR, either by lowering the toy into the vat, or by raising the vat around the toy, or a combination of lowering the toy and raising the vat. After the toy is dipped into the TPR, the toy is removed from the TPR and dried, resulting in a TPR-coated canvas pet toy.

The process is not limited to canvas. In another preferred embodiment, a pet toy is formed with rope, and dipped into a vat of dyed TPR. In the resultant product, the TPR provides the color rather than the underlying material. Alternatively, the rope could be colored or provided having a pattern, illustration, or design, and be dipped in transparent TPR. Likewise, a canvas toy could be dipped in dyed TPR. Portions of the object may be covered before dipping, allowing for a partially TPR-coated object.

By providing a TPR-coating that can conform to an irregular shape on a pet toy, the underlying toy is protected from damage when the pet chews on the toy, and thus the toy's life is lengthened.

The process is not limited to pet toys; it will be apparent to one of skill in the art that the process is suitable for use with a variety of materials in a variety of applications, such as providing an insulating coating for wires, a grip for writing utensils, or any other application in which a TPR coating would be useful.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrated an uncoated ball toy;

FIG. 2 illustrated an uncoated rope toy;

FIG. 3 illustrated an uncoated canvas dog toy;

FIG. 4 illustrated a TPR-coated ball toy;

FIG. 5 illustrated a TPR-coated rope toy;

FIG. 6 illustrated a TPR-coated canvas dog toy;

FIG. 7 illustrates a canvas dog toy hung for dipping in a thermoplastic rubber coating solution according to a preferred embodiment of the present invention;

FIG. 8 illustrates a canvas dog toy dipped in a vat of thermoplastic rubber coating solution;

FIG. 9 illustrates the canvas dog toy being removed from the vat of thermoplastic rubber coating solution, wherein excess thermoplastic rubber coating solution drips onto a drying channel;

FIG. 10 illustrated a vat of thermoplastic rubber material, with bonding agent, and dye being added;

FIG. 11 illustrates a vat of liquified thermoplastic rubber into which the canvas dog toy is dipped;

FIG. 12 is a flowchart illustrating the steps of coating an object according to a preferred embodiment of the present invention;

FIG. 13 is a flowchart illustrating the steps of forming thermoplastic rubber coating solution;

FIG. 14 is a flowchart illustrating the steps of coating an object by raising and lowering a hanging apparatus;

FIG. 15 is a flowchart illustrating the steps of coating an object by raising and lowering a vat;

FIG. 16 is a flowchart illustrating the steps of removing the thermoplastic rubber coating and manipulating the object underneath; and

FIG. 17 is a flowchart illustrating the steps of adding color to and heating the thermoplastic rubber coating solution.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The embodiments disclosed in the present invention provide a method of coating an object 9 or a portion of an object with thermoplastic rubber 15 (TPR). This method is especially useful for objects 9 which may be irregularly-shaped or otherwise difficult to coat using other coating methods, although it is suitable for virtually any object 9 for which a TPR coating 15 is desired.

In the preferred embodiment, a method of applying thermoplastic rubber coating 15 is provided, said method comprising gripping an object 9 to be coated, contacting said object 9 with a thermoplastic rubber coating solution 14, and curing said object 10, wherein said thermoplastic rubber coating 15 is formed after said object 10 is cured.

The thermoplastic rubber coating solution 14 is formed by filling a vat 12 with thermoplastic rubber material 13 and a bonding agent 17, and mixing said thermoplastic rubber material 13 and said bonding agent 17, wherein said bonding agent 17 acts to convert said thermoplastic rubber material 13 from a solid to a liquid. The ratio of said thermoplastic rubber material 13 to said bonding agent 17 ranges between 1:2 to 1:5, with a preferred embodiment having a ratio of 1-part thermoplastic rubber material 13 to 3.5-parts bonding agent 17 (1:3.5). The thermoplastic rubber material 13 and bonding agent 17 are left to react for a time range between 24-48 hours, wherein the chemical reaction between the two materials renders said thermoplastic rubber coating solution 14 as a liquid.

The bonding agent 17 comprises any chemical composition, solution, or material capable of rendering or otherwise liquifying thermoplastic rubber material 13 into a liquid form. In the preferred embodiment, the bonding agent 17 is a glue comprising polyurethane glue, cyanoacrylate glue, rubber cement, polyvinyl acetate, petroleum, hexane, toluene, methyl ethyl ketone, butanone, acetone, or any other solution, solvent, or active matrix capable of melding rubber followed by a flash-off curing process. In the preferred embodiment, the bonding agent 17 is non-toxic.

Prior to liquification, the thermoplastic rubber material 13 is transparent. This allows the color of the object 10 to show through the thermoplastic rubber coating 15. However, if coloring is desired, one or a plurality of dyes 18 are mixed into said thermoplastic rubber coating solution 14, wherein said one or a plurality of dyes 18 change the color of said thermoplastic rubber coating solution 14.

After the thermoplastic rubber coating solution 14 is formed in said vat 12, it is ready to be applied to an uncoated object 9. First, the uncoated object is gripped by a hanging apparatus 16, and it is then put in contact with said thermoplastic rubber coating solution 14 until a desired thickness is provided. In the preferred embodiment, said uncoated object 9 is hanging from a hanging apparatus and said vat is lifted such that said thermoplastic rubber coating solution 14 is put in contact with said uncoated object 9. In an alternative embodiment, said uncoated object 9 is hanging from a hanging apparatus and said hanging apparatus 16 is lowered such that said thermoplastic rubber coating solution 14 is put in contact with said uncoated object 9.

After coating, the coated object 10 is removed from said vat 12 by lowering said vat 12 or raising said hanging apparatus 16. The hanging apparatus 16 will then move said coated object 10 above a drying channel 20, where excess thermoplastic rubber coating solution 14 will drop from said coated object 10 into said drying channel. The coated object 10 will then cure over a range between 24-28 hours, wherein the curing converts the thermoplastic rubber coating solution from a liquid to a solid.

In alternative embodiments, portions of the coated object 10 may need to be uncoated, for example, to allow portions of the coated object 10 to project outward. Here, a portion of the thermoplastic rubber coating 15 may be removed from said coated object 10. In a further alternative embodiment, a portion of said uncoated object 9 are covered or otherwise obstructed from coming in contact with said thermoplastic rubber coating solution 14 to prevent said portions from contacting said portions. Furthermore, these uncoated portions may be manipulated to enable parts of the object 9, 10 to protrude from the surface. In further alternative embodiments, the uncoated object 9 may be processed, sanded, treated, or otherwise manipulated prior to contacting said thermoplastic rubber coating solution 14 to encourage bonding, gripping, thickness, or other desirable properties. In yet a further alternative embodiment, if portions of the object 10 are uncoated due to obstruction from the hanging apparatus 16, they may optionally be filled in with thermoplastic rubber coating solution 14 to ensure a smooth and even finish.

In yet a further alternative embodiment, a method of applying thermoplastic rubber coating is provided, said method comprising gripping an object 9 to be coated, contacting said object with a thermoplastic rubber coating solution 14, said thermoplastic rubber coating solution formed by filling a vat 12 with thermoplastic rubber material 13, wherein object 10, wherein said thermoplastic rubber coating 15 is formed after said object 10 is cured.

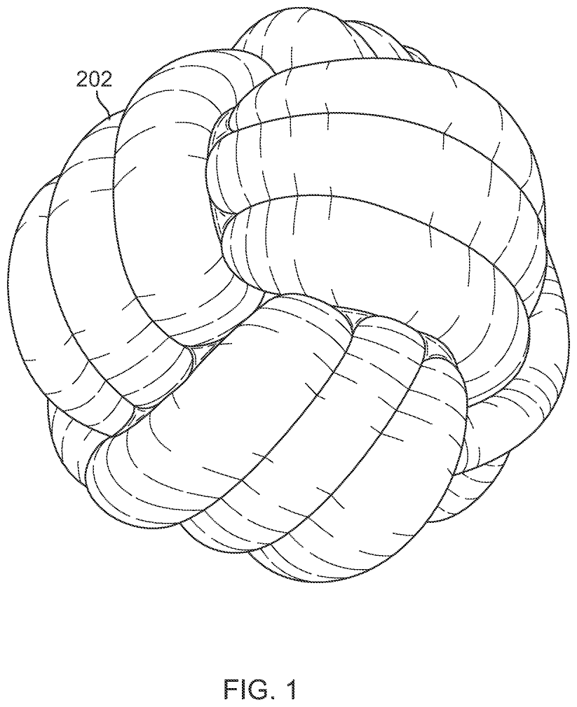

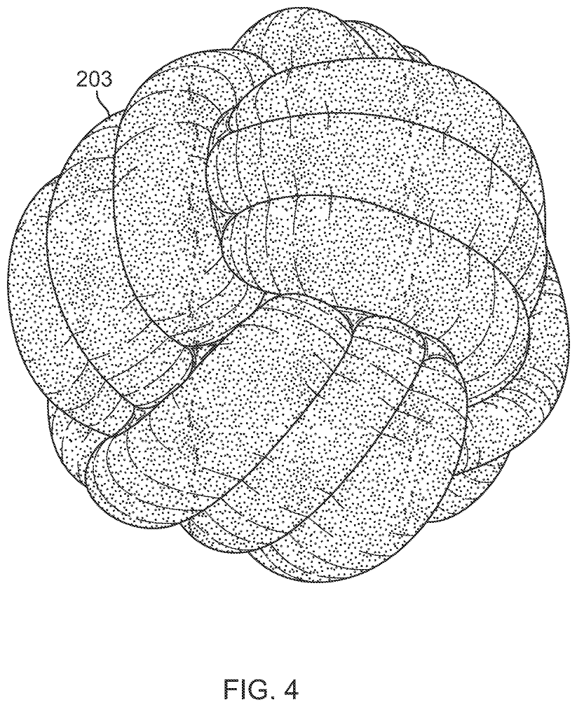

Referring initially to FIG. 1, a ball toy 202 is illustrated. The ball toy 202 is made by fashioning rope material into a desired shape, illustrated herein as a ball. FIG. 4 illustrates how said ball toy 204 will look after dipping the ball toy 202 in TPR 14. The ball toy 203 is illustrated as having been dipped in a dyed TPR 14, thus having the color of the dyed TPR 14 as opposed to being transparent, although transparent TPR can be used.

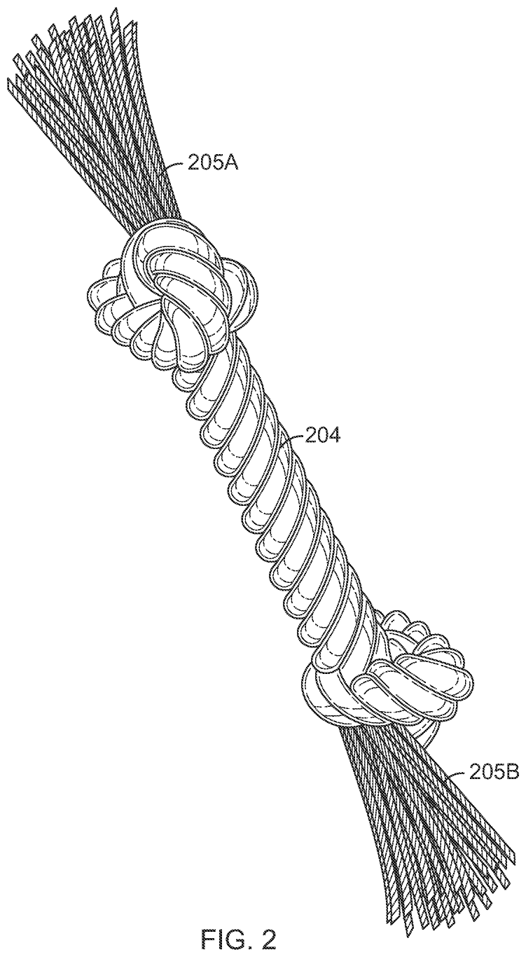

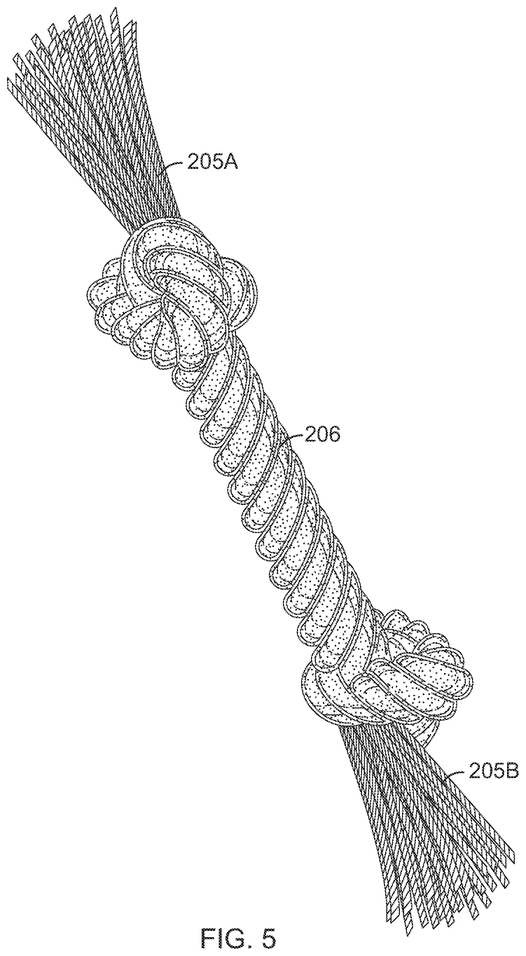

Referring now to FIG. 2, a rope toy 204 is illustrated. The rope toy 204 is made by fashioning rope material into a desired shape, illustrated here as having an elongated body with opposing flared ends 205A and 205B. FIG. 5 illustrates said rope toy 206 will look after dipping said rope toy 204 in TPR 14. Before the rope toy 204 is coated, ends 205A and 205B were covered so that the dipping process coated all of rope toy 206 except ends 205A and 205B. Alternatively, the TPR coating 15 can be manually removed, after which ends 205A and 205B are flared outward.

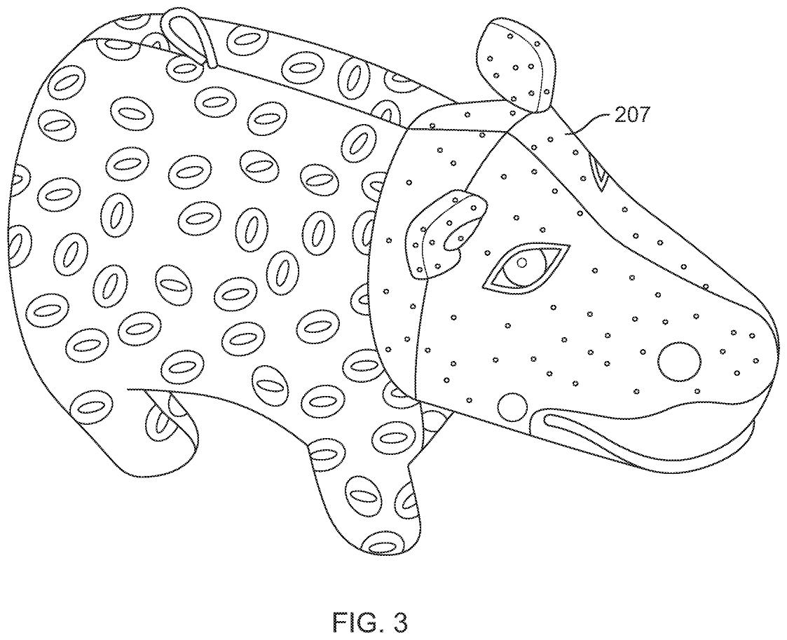

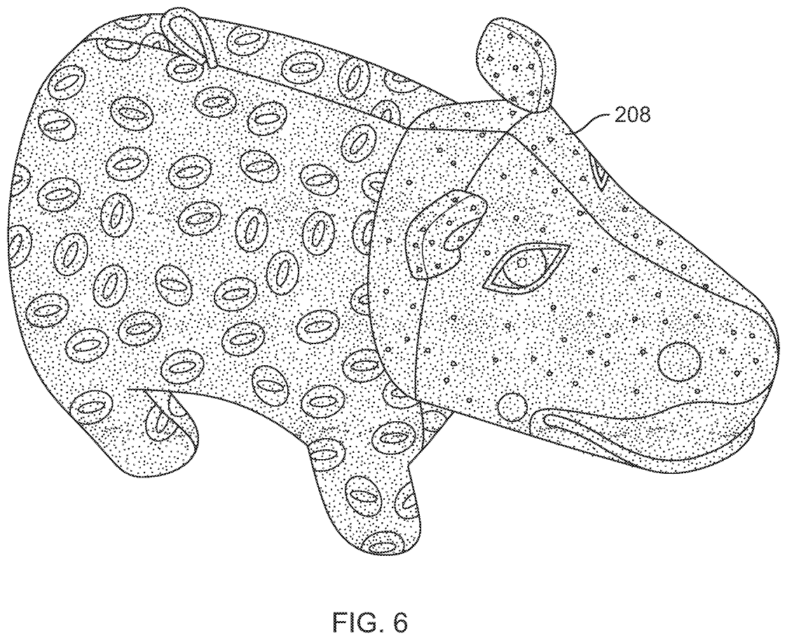

Referring now to FIG. 3, a canvas dog toy 207 is illustrated. The canvas dog toy 207 is made by forming ballistic nylon into a desired shape, illustrated here as a small animal. FIG. 6 illustrates how said canvas dog toy 208 will look after dipping said canvas dog toy 207 in TPR 14. The canvas dog toy 208 is illustrated as having been dipped in a transparent TPR 14, omitting any coloring or dye 18, such that the underlying colors, patterns, and designs on the canvas itself, including a logo for branding, are visible through the TPR coating 15.

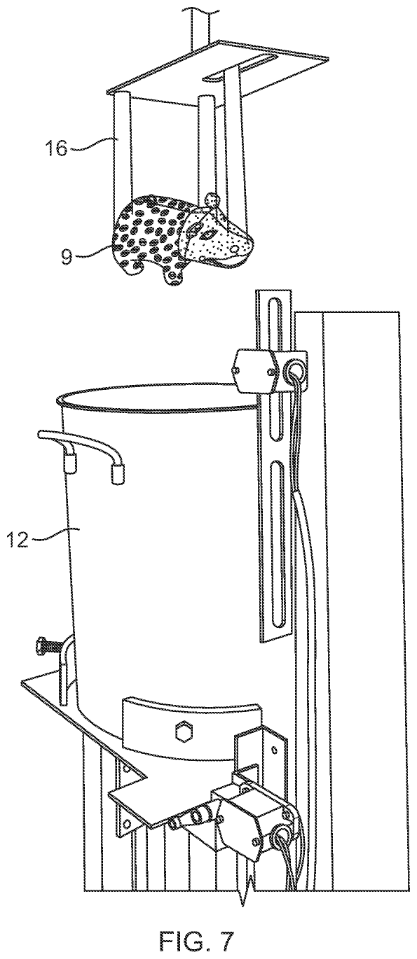

Referring initially to FIG. 7, an animal-shaped canvas dog toy 207 is illustrated. The canvas dog toy 207 is suspended over a vat 12 containing liquified thermoplastic rubber coating solution 14. The suspension of canvas dog toy 207 is accomplished with a hanging apparatus 16. As illustrated, canvas dog toy 207 is provided with patterns and designs on the canvas itself, and is thus particularly suitable for coating with transparent TPR 14. Where an object 9 is intended to have a solid color, either the object itself or the TPR 14 may be colored, or both if desired. Dye 18 may be added to melted TPR 14 to provide an inexpensive coloring for a TPR-coated object 10.

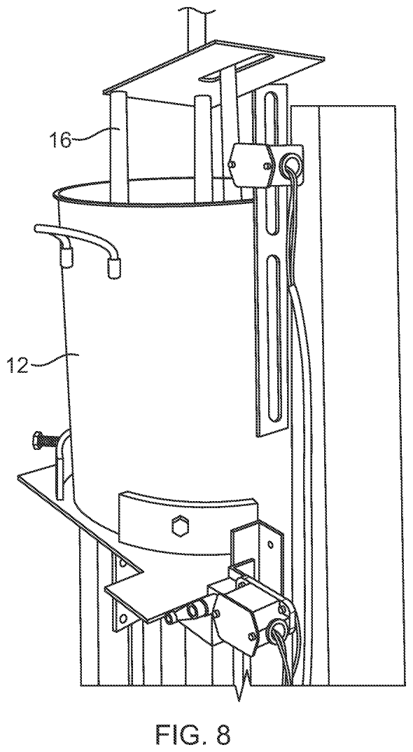

Referring now to FIG. 8, the canvas dog toy 207 is inserted into the vat 12 containing liquified TPR 14. In one embodiment, this is accomplished by raising the vat 12 so that the TPR 14 surrounds the canvas dog toy 207. In an alternative embodiment, the canvas dog toy 207 is lowered into the vat 12 containing the TPR 14.

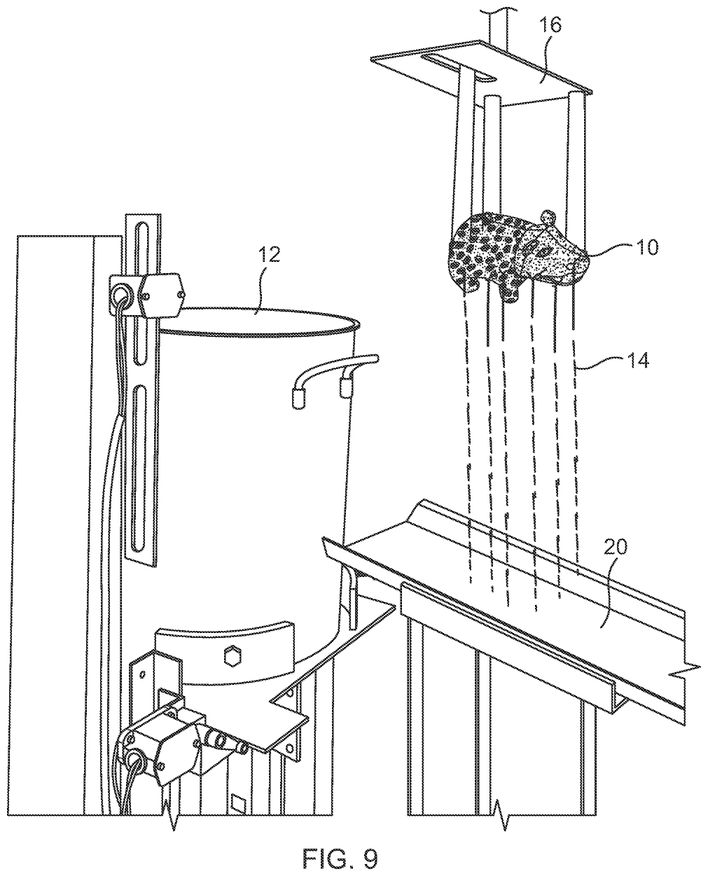

Referring now to FIG. 9, after the insertion (or “dipping”) of the canvas dog toy 207 in the melted TPR 14, the canvas dog toy 208 is removed from the TPR 14. In preferred embodiments, this is accomplished by the opposite process used for the insertion, e.g., if the vat 12 was raised in order to insert the canvas dog toy 207 into the TPR 14, then the vat 12 is lowered to remove the canvas dog toy 208 from the TPR 14. Likewise, if the canvas dog toy 207 was lowered for the dipping, it is raised to remove it from the TPR 14.

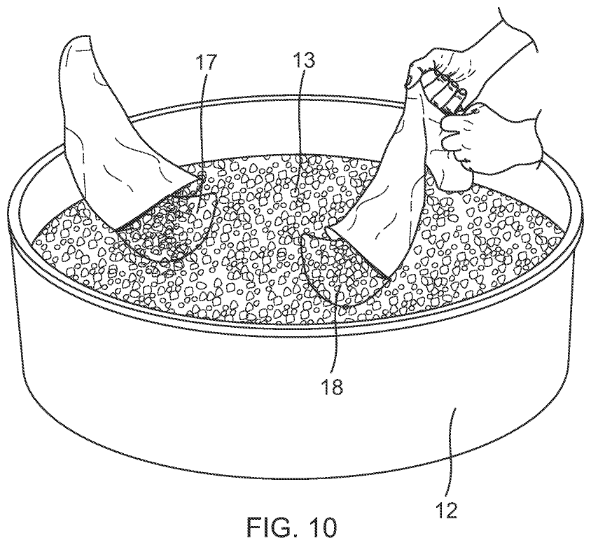

As shown in FIG. 10, after the canvas dog toy 208 is dipped in the melted TPR 14, it is allowed to cure or dry, forming a thermoplastic rubber coating 15. A drying channel 20 is illustrated to show the drying of canvas dog toy 208 according to a preferred embodiment. The excess TPR 14 is collected in the drying channel 20 and either reused or otherwise disposed of.

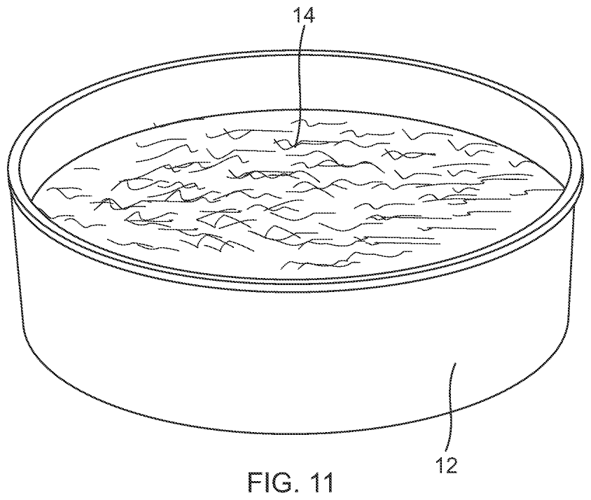

Referring now to FIG. 11, the TPR solution 14 is formed by filling the vat 12 with a desired amount of TPR material 13, illustrated here as TPR pellets. The TPR material 13 is solid at room temperature. The bonding agent 17 and, optionally, one or a plurality of dyes 18 are then added to the vat 12. The bonding agent 17 begins a chemical reaction, liquifying the TPR material 13, as illustrated in FIG. 11. Alternatively, a heating source is applied to the vat 12 until the TPR material 13 exceed its melting point, after which the TPR material 13 is provided as a TPR coating solution 14 in liquid form. The TPR coating solution 14 may optionally be mixed to ensure the temperature and color are distributed evenly throughout the solution.

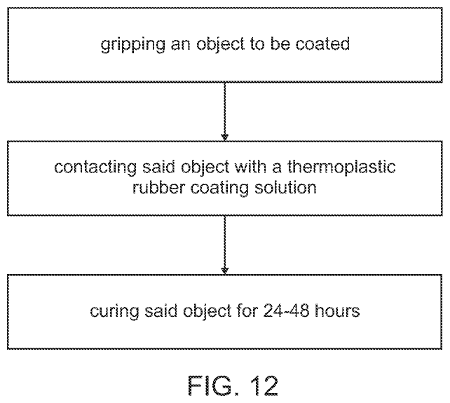

Referring now to FIG. 12, a flowchart illustrating a preferred embodiment of a TPR dipping process is shown. Here, an object is provided for coating in TPR 15, which is gripped, put into contact with said TPR solution 14, and cured. Illustrated in FIGS. 1-6 are various pet toys according to an exemplary use of this process; however, any object 9 suitable for a TPR coating 15 may be used.

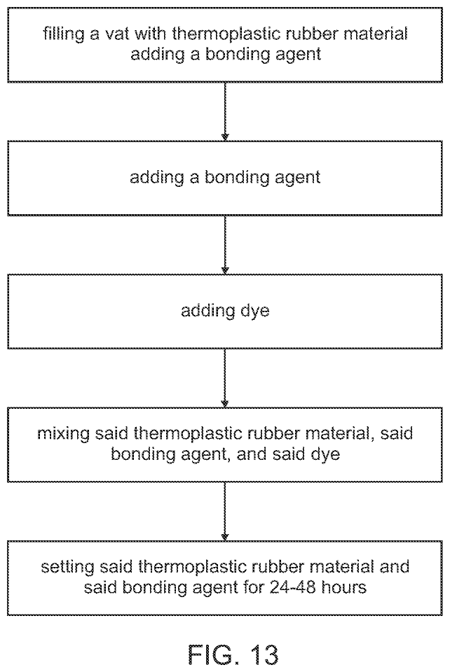

FIG. 13 is a flowchart illustrating the process of making the TPR solution 14, where a vat 12 is filled with thermoplastic rubber material 13, a bonding agent 17 is added to the vat 12, and dye 18 is added to the vat 12, after which the contents are mixed and left to set for 24-48 hours.

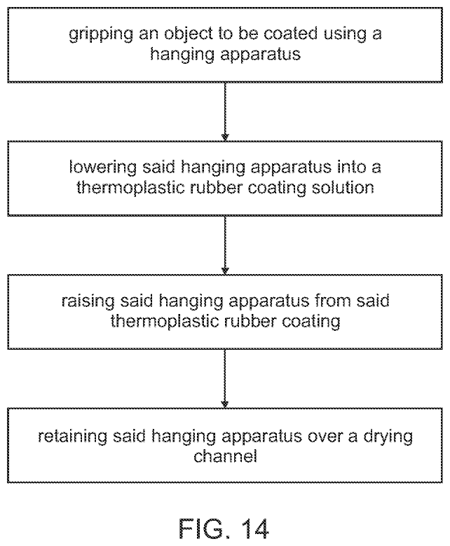

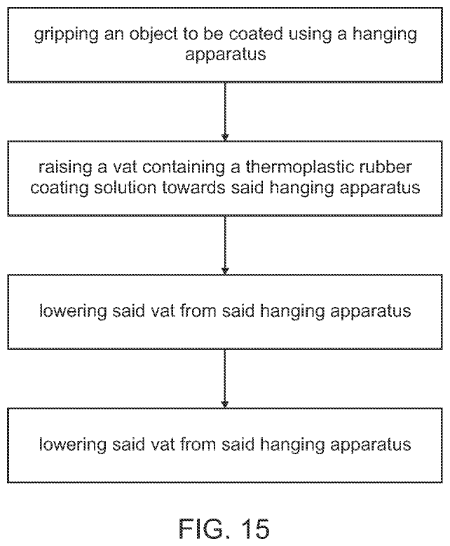

FIGS. 14-15 are flowcharts which illustrating the process of coating an object 9. In preparation for dipping the object 9, it is suspended in the air by gripping and placing it on a hanging apparatus 16. It will be apparent to one of skill in the art that this process may be performed at any time, and need not wait for the preparation of the TPR solution 14. As discussed above, the dipping may be accomplished in any manner which results in the immersion or at least partial insertion of the object 9 in the TPR solution 14. In a preferred embodiment, this is accomplished by raising the vat 12, and in an alternative preferred embodiment, this is accomplished by lowering the object 9. After the dipping, the object 10 is removed from the TPR solution 14 and allowed to dry. The drying process may be enhanced and expedited with the addition of heating or cooling fans, constant air movement, or a combination thereof.

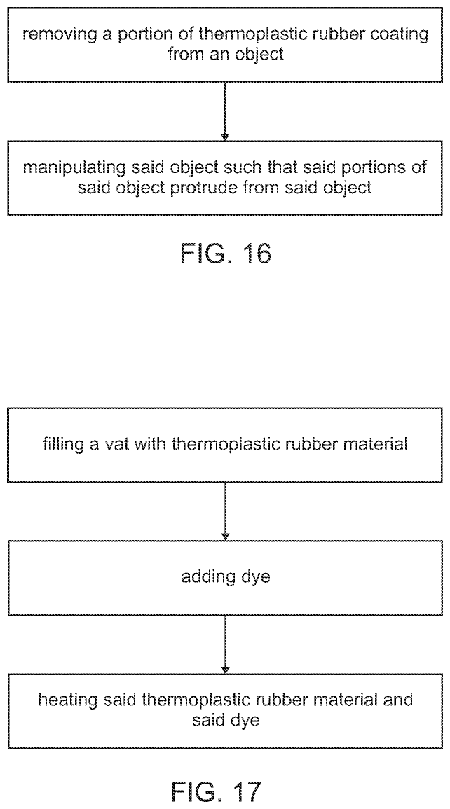

FIG. 16 is a flowchart illustrating a process for dipping only a portion of the object 9 into the TPR solution 14. Here a portion of the TPR coating 15 is removed from the object 10, after which the object 10 may be manipulated to cause portions of said object 10 to protrude from the surface. Alternatively, if it is desired that only a portion of the object 10 be coated, the remainder may be covered. For example, portions that need not be coated in TPR 15 may be wrapped in a plastic having a higher melting point than the TPR 14 being used.

FIG. 17 is a flowchart illustrating an alternative process for melting TPR material 13. Here, a heating source is applied to the TPR material 13 in a vat 12, raising the temperature of the TPR material 13 to at least its melting point. Using a preferred TPR material 13, the melting point for this material is ranging between 58 degrees C. to 60 degrees C. (about 136 to 140 degrees F.). However, other TPR formulations may be used having different melting temperatures without departing from the present invention. Dye 18 may optionally be added.

While there have been shown what are presently considered to be preferred embodiments of the present invention, it will be apparent to those skilled in the art that various changes and modifications can be made herein without departing from the scope and spirit of the invention.

While the above description contains specific details regarding certain materials, shapes, and other teachings, it is understood that embodiments of the invention or any combination of them may be practiced without these specific details. These details should not be construed as limitations on the scope of any embodiment, but merely as exemplifications of the presently preferred embodiments. In other instances, well known structures, elements, and techniques have not been shown to clearly explain the details of the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A method of applying thermoplastic rubber coating, said method comprising:
gripping an object to be coated;
contacting said object with a thermoplastic rubber coating solution; and
curing said object;
wherein said thermoplastic rubber coating solution is cured, forming a thermoplastic rubber coating.

2. The method of claim 1, wherein said thermoplastic rubber coating solution is formed by filling a vat with thermoplastic rubber material and a bonding agent, and mixing said thermoplastic rubber material and said bonding agent, wherein said bonding agent acts to convert said thermoplastic rubber material from a solid to a liquid.

3. The method of claim 2, wherein the ratio of said thermoplastic rubber material to said bonding agent ranges between 1:2 to 1:5.

4. The method of claim 2, wherein said thermoplastic rubber material and said bonding agent react between 24-48 hours, wherein the chemical reaction between the two materials renders said thermoplastic rubber coating solution as a liquid.

5. The method of claim 2, wherein said thermoplastic rubber material is transparent.

6. The method of claim 2, further comprising mixing one or a plurality of dyes to said thermoplastic rubber coating solution, wherein said one or a plurality of dyes change the color of said thermoplastic rubber coating solution.

7. The method of claim 1, wherein said contacting further comprises dipping said object in said thermoplastic rubber coating solution until a desired thickness is provided.

8. The method of claim 2, wherein said object is hanging from a hanging apparatus and wherein said vat is lifted such that said thermoplastic rubber coating solution is in contact with said object.

9. The method of claim 2, wherein said object is hanging from a hanging apparatus and wherein said hanging apparatus is lowered such that said thermoplastic rubber coating solution is in contact with said object.

10. The method of claim 1, wherein said curing further comprises hanging said object over a drying channel, where excess thermoplastic rubber coating solution will drip from said object and into said drying channel.

11. The method of claim 1, wherein said curing ranges between 24-48 hours, and wherein said curing converts said thermoplastic rubber coating solution from a liquid to a solid.

12. The method of claim 1, wherein said object is a pet toy.

13. The method of claim 1, further comprising removing a portion of said thermoplastic rubber coating solution from said object.

14. The method of claim 1, further comprising sealing a portion of said object such that said thermoplastic rubber coating solution is prevented from contacting said object.

15. The method of claim 1, further comprising manipulating a portion of said object such that said manipulated portion protrude outward from said object.

16. The method of claim 1, wherein the surface of said object is treated prior to contacting said object with said thermoplastic rubber coating solution.

17. The method of claim 1, wherein the surface of said object is processed prior to contacting said object with said thermoplastic rubber coating solution.

18. A method of applying thermoplastic rubber coating, said method comprising:
gripping an object to be coated;
contacting said object with a thermoplastic rubber coating solution, said thermoplastic rubber coating solution formed by filling a vat with thermoplastic rubber material, melting said thermoplastic rubber material, and mixing said thermoplastic rubber material; and
curing said object;
wherein said thermoplastic rubber coating is formed after said object is cured.
